(19) United States
(12) Patent Application Publication
(10) Pub. No.: US 2016/0348758 A1
(43) Pub. Date: Dec. 1, 2016

(54) PUMPJACK WITH TORQUE-BALANCED GEARBOX

(71) Applicants: Xihua SUI, Edmonton (CA); Jiaji WANG, Edmonton (CA); Zhengming WANG, Edmonton (CA)

(72) Inventors: Xihua SUI, Edmonton (CA); Jiaji WANG, Edmonton (CA); Zhengming WANG, Edmonton (CA)

(21) Appl. No.: 15/166,580

(22) Filed: May 27, 2016

Related U.S. Application Data
(60) Provisional application No. 62/167,545, filed on May 28, 2015.

(51) Int. Cl. F16H 1/06; E21B 43/12; F16H 35/00; F16H 1/20; F16H 55/08

(52) U.S. Cl. CPC F16H 1/06; F16H 1/20; F16H 55/084; F16H 35/00; E21B 43/127; F16H 2035/003

(57) ABSTRACT

A torque balancing gearbox for a pumpjack includes a first non-circular gear engaging a second non circular gear. Each non-circular gear has a centre of rotation and a radius R1 or R2 from the centre of rotation to the point of engagement of the other non-circular gear. The sum of R1 or R2 remains constant through a rotation cycle, while the ratio R1/R2 varies from a minimum below 1.0 to a maximum above 1.0

### FIELD OF THE INVENTION

The present invention relates to a pumpjack with a torque-balanced gearbox.

### BACKGROUND

A gearbox is a conventional apparatus used to transmit energy and movement via velocity reduction or increase and torque transmission. In operation, the payload that the equipment bears normally differs from the resistance it encounters, which then leads to unwanted torque imbalances. For instance, the torque a lathing machine tolerates is remarkably lower when performing cutting work than that while it idles.

In a walking beam pump, also known as a pumpjack, widely used in oil and gas production, the upstroke requires significantly higher torque production from a motor than in the downstroke, which may in fact have negative torque due to the weight of the rod string. This torque imbalance, which may be partially reduced by the gearbox, still heavily applies to the motor, which may cause the working current to be unsteady, efficiency to drop and reactive power to increase.

This torque imbalance may be mitigated by a counterbalance block to the gearbox shaft, which partially alleviates the imbalance. However, the payload and counterbalance block are different and are difficult to synchronize; their net torque is far from balanced. This imbalanced torque then inevitably imposes on the motor.

### SUMMARY OF THE INVENTION

In one aspect, the invention may comprise a pumpjack comprising a gearbox having a drive input and a load output, and comprising a first non-circular gear driven by the drive input and driving a second non circular gear which drives the load output, each non-circular gear having a centre of rotation, and having a radius R1 or R2 respectively from the centre of rotation to the point of engagement with the other gear. R1 and R2 each varies as the non-circular gear rotates, however, the sum of R1 or R2 remains substantially constant through a rotation cycle, while the ratio R1/R2 varies from a minimum below 1.0 to a maximum above 1.0.

In one embodiment, the torque required from a motor driving the pumpjack is thus relatively uniform throughout a pump cycle.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 (Prior Art). Schematic depiction of working cycle for prior art pumpjack.

FIG. 2 (Prior Art). Graph showing torque curves for working cycle of the prior art pumpjack of FIG. 1.

FIG. 3. One embodiment of a pumpjack of the present invention.

FIG. 4A. A schematic depiction of one embodiment of a balanced gearbox. FIG. 4B shows the gearbox in top plan cutaway view.

FIG. 5. A schematic depiction of a working cycle of one embodiment of a pumpjack having a balanced gearbox.

FIG. 6. Graph showing torque curves for working cycle of the pumpjack of FIG. 5.

FIG. 7A. An alternative embodiment of a pumpjack of the present invention. FIG. 7B shows the gearbox in top plan cutaway view.

FIG. 8. A further alternative embodiment of a pumpjack with a torque balanced gearbox.

FIG. 9. A further alternative embodiment of a pumpjack with a torque balanced gearbox.

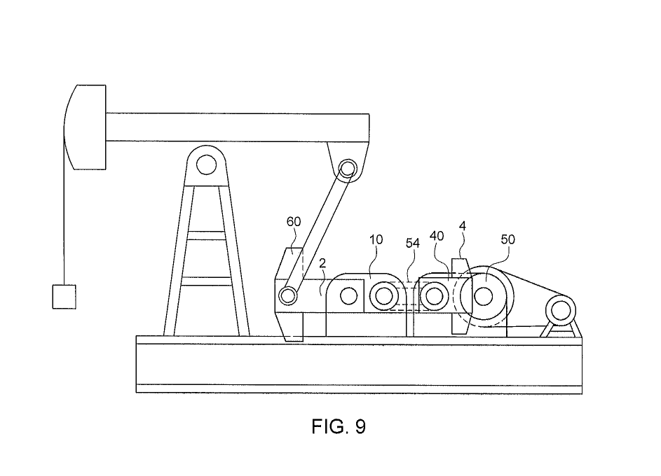

### DETAILED DESCRIPTION

As used herein, the recited terms have the following meanings. All other terms and phrases used in this specification have their ordinary meanings as one of skill in the art would understand.

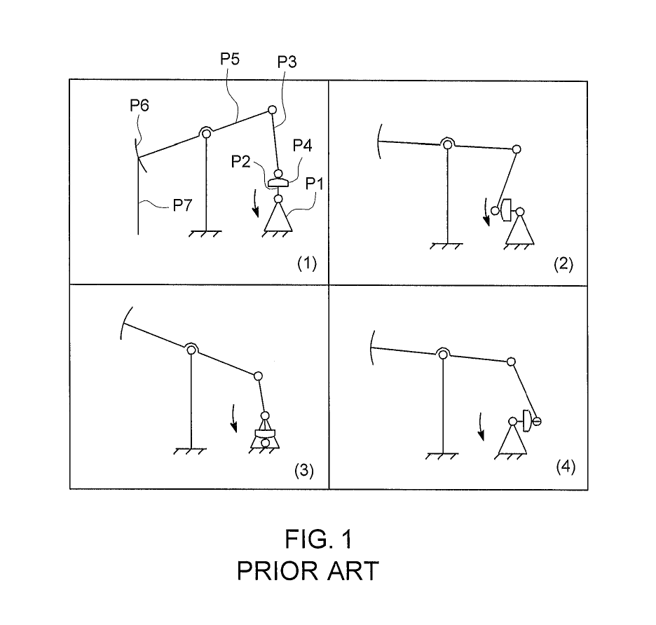

To facilitate understanding of the present invention, the operation of a conventional prior art pumpjack is described. The schematic representation of a pumpjack shown in FIG. 1 comprises a drive means which is conventionally an electric motor (P1), a first crank arm (P2), a lever arm (P3), a counterweight (P4), walking beam (P5), horsehead (P6), and sucker rod (P7). The drive means (P1) generates rotational power (torque) which is transmitted to the sucker rod (P7) by the components shown. A gearbox may be included which reduces rotational speed and increases torque. The pumpjack is shown at four different points during its cycle:
1—Pump is at end of downstroke, or start of upstroke (0° crank rotational angle or) 360°;
2—Pump is midway through upstroke (90°);
3—Pump is at end of upstroke, or start of downstroke (180°); and
4—Pump is midway through downstroke (270°).

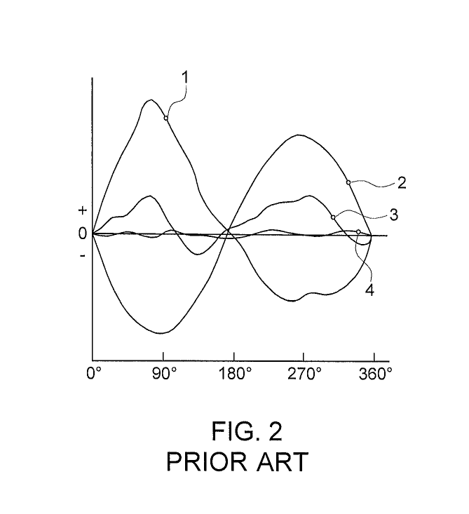

The torque curves generated by this prior art configuration are shown in FIG. 2. Curve 1 is the torque applied to the sucker rod (P7). Curve 2 presents the torque applied to counter-balance weight (P4). Curve 3 presents the net torque between curve 1 and 2. Curve 4 presents the inertial torque of the system.

In one aspect, the present invention comprises a torque-balanced gearbox adapted to mitigate torque imbalances during a cycle of a reciprocating pumpjack driven by a motor, such as an electric motor. In one embodiment, the gearbox is configured to achieve a theoretic zero or negligible net torque at all points through the pump working cycle. This is achieved by the implementation of a gearbox comprising a pair of non-circular gears. The curve radius of these two gears, based on mathematical calculation, is synchronized to the pace of the torque change throughout the movement circle of the gearbox. The curve radius is the distance between the center of rotation of the gear, and the point of its engagement with the other non-circular gear. With synchronization between the gear curve radius and the pace of the gear movement circle, the torque imbalance can be entirely or substantially cancelled out, thus the net output torque of the gearbox literally becomes zero. This torque balance improvement, makes the working current completely stable, and may therefore reduce the power consumption by improving the power factor.

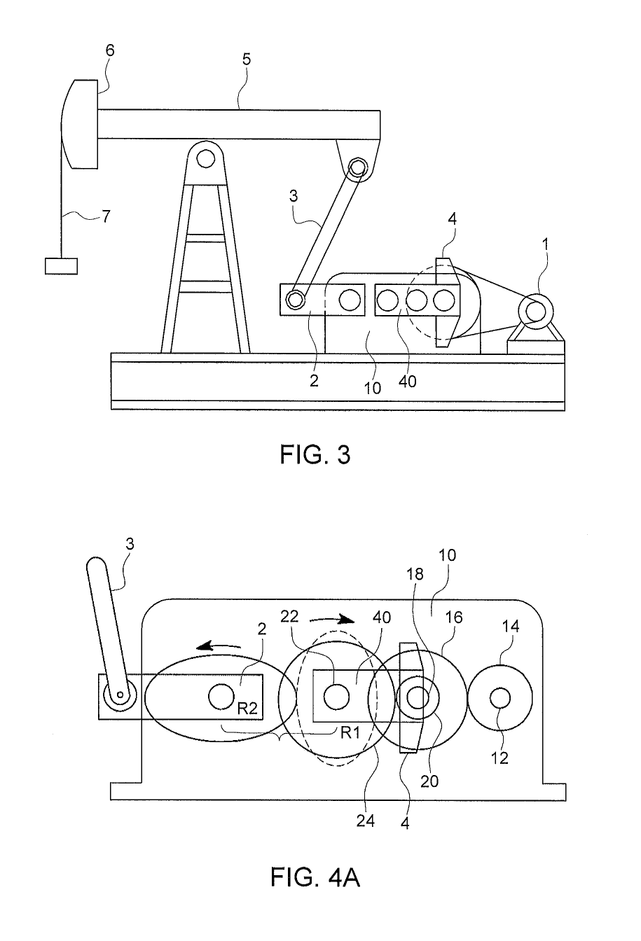

One embodiment of the invention is shown in FIG. 3, where a drive means comprising an electric motor (1) rotates a first crank arm (2), a second crank arm (3) pivotally connected to the first crank arm, a counterweight (4), walking beam (5) pivotally connected to the second crank arm, horsehead (6), and sucker rod (7) are configured in conventional fashion. The gearbox (10) is positioned between the drive means (1) and the first crank arm (2).

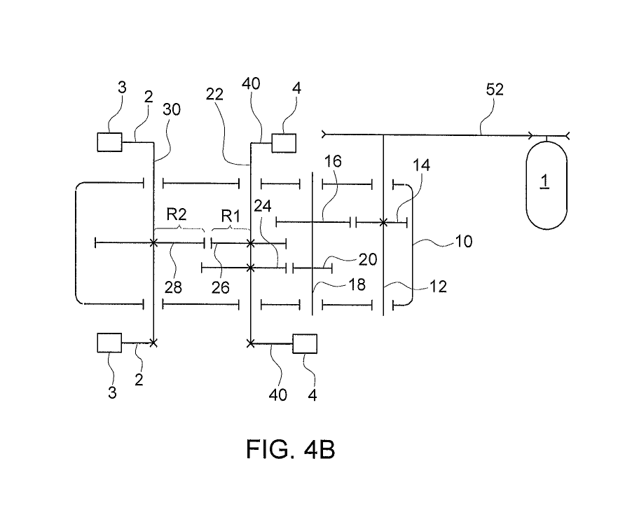

As shown in FIGS. 4A and 4B, the gearbox (10) comprises an input shaft (12), a first drive gear (14) mounted on the input shaft (12), and a second drive gear (16) mounted on a first intermediate shaft (18). A third drive gear (20) on the first intermediate shaft engages a fourth drive gear (24) mounted on a second intermediate shaft (22).

A first non-circular gear (26) driven by the second intermediate shaft (22) engages a second non-circular gear (28) mounted on an output shaft (30). Each of the non-circular gears have a radius (R1 and R2 respectively) between their center of rotation and the gear tooth contacting the other non-circular gear. The sum of R1+R2 remains constant, while the ratio of R1/R2 varies between a minimum <1.0 and a maximum >1.0. This constant radii sum (R1+R2) may be achieved either by elliptical shapes, as shown in FIG. 4A, or by a circular shape with a non-centered center of rotation. In FIG. 4, R1 is at a minimum while R2 is at a maximum. If R1/R2 is less than 1.0, the gearbox outputs to the first lever arm (2) reduced speed and increased torque. Where R1/R2 is greater than 1.0, the gearbox outputs increased speed to the first lever arm and decreased torque. The ratio of R1/R2 at any given point in the cycle may be designed to achieve the desired torque balance, by altering the shape of the non-circular gears. In one embodiment, the ratio of R1/R2 is calculated and the non-circular gears are configured to synchronize with the constantly changing ratios between the torques applied to the first and second non-circular gears. The non-circular gears preferably have the same shape and the same number of teeth.

The number of gears and shafts in the gearbox may be configured by one skilled in the art to achieve a desired overall gear ratio. The configuration shown in FIGS. 4A and 4B is one exemplary embodiment.

In one embodiment, a counterweight (4) is attached to a balance crank arm (40) and is associated with and rotates with the first non-circular gear (26) on the third shaft (22).

The drive means may comprise any conventional drive for a pumpjack, such as an internal combustion motor or an electric motor. In one embodiment, the drive means comprises an electric motor (1) which drives the input shaft (12) by means a belt drive (52), as is well known in the art.

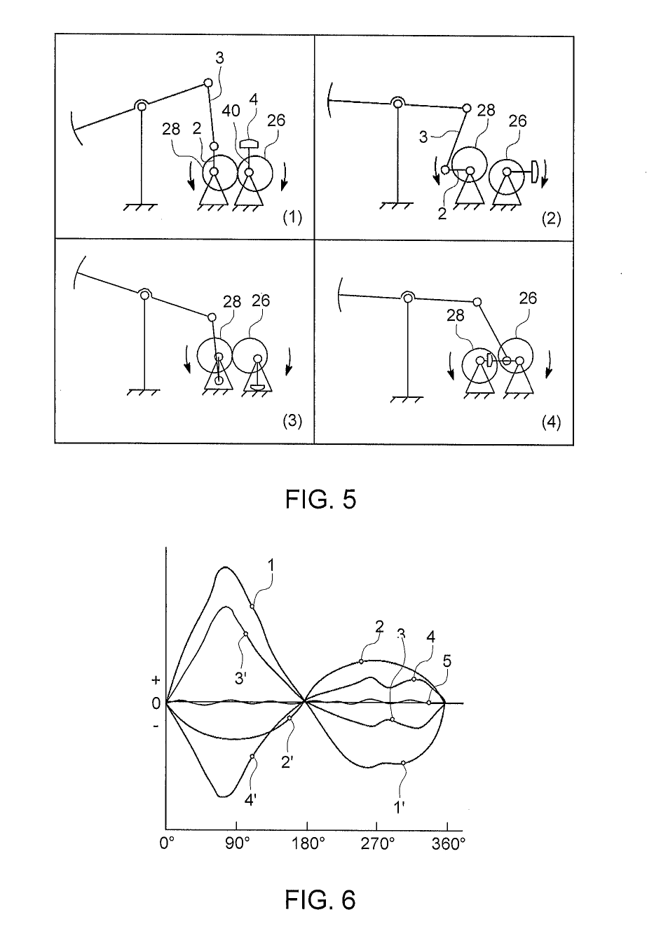

FIG. 5 shows a pumpjack with the balanced gearbox of the present invention at four different points during its cycle:
1—Pump is at end of downstroke, or start of upstroke;
2—Pump is midway through upstroke;
3—Pump is at end of upstroke, or start of downstroke; and
4—Pump is midway through downstroke.

The counterweight (4) is attached to a balance crank (40) and is associated with and rotates with the first non-circular gear (14). The counterweight (4) is synchronized to the movement of the horsehead and sucker rod, such that the counterweight is at its highest position (12 o'clock, position 1 in FIG. 5) when the pump is at the end of its downstroke. In position 2 (3 o'clock), the counterweight is adding maximal torque to the gearbox output at the midpoint of the upstroke. In position 3 (6 o'clock), the counterweight is in it lowest position when the pump is at the end of its upstroke. In position 4 (9 o'clock), the counterweight is resisting the torque output.

By utilizing the non-circular gears and a counterweight/balance crank, a theoretical zero net torque applied to motor can be achieved.

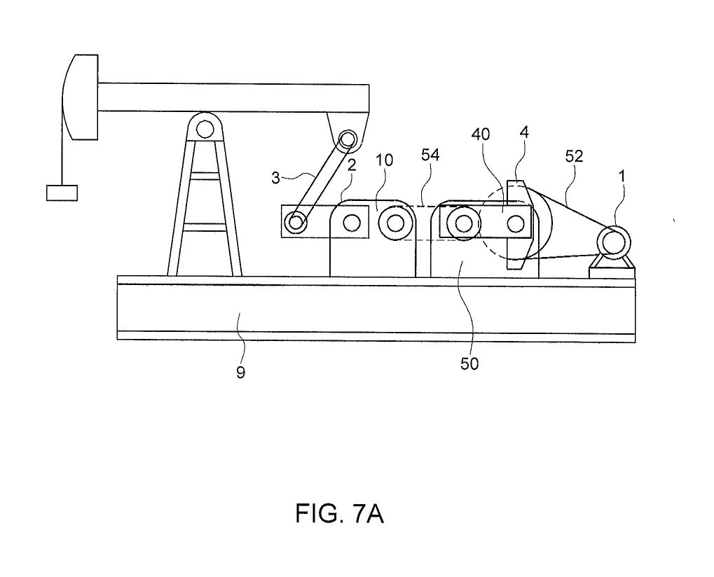

FIG. 6 shows the torque curves for the pumpjack schematically shown in FIG. 5. Curve 1 presents the torque applied to the sucker rod. Curve 2 presents the torque applied to the first crank arm (2). Curve 3 presents the net torque between curve 1 and 2. Curve 4 presents the torque applied to balance crank arm (symmetrical about zero to Curve 3). Curve 5 presents the overall net torque (equals to zero theoretically) of curves 3 and 4.

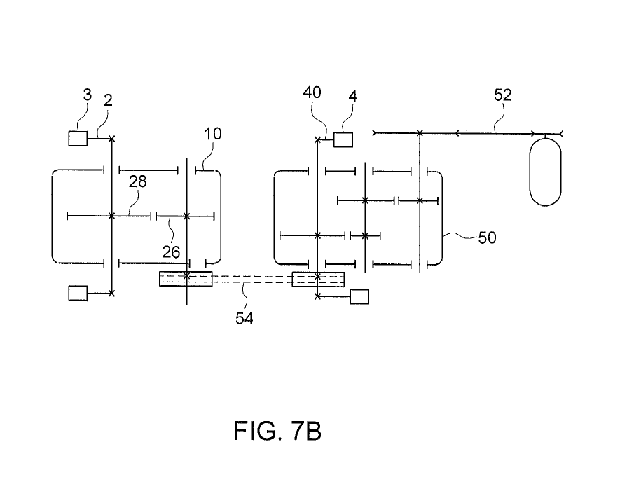

Alternative configurations of the balanced gearbox may be implemented with a pumpjack. In the pumpjack shown in FIGS. 4A and 4B, the horizontal distance between the first and second intermediate shafts (18, 22) is rather close, which may cause overlap and interference between the first crank arm (2) and balance crank arm (40). In order to eliminate this possible interference, as shown in FIG. 7, separation of the balance crank (40) from the first crank arm (2) is created by using a reduction gearbox (50), separate from the torque balancing gearbox (10). The reduction gearbox (50) is connected to the motor (1) via a driving belt (52) and is configured to provide a gear ratio which reduces speed. The reduction gearbox passes the power to the balanced gearbox (10) through a chain or belt (54). The fully balanced gearbox (10) comprises first and second non-circular gears (26, 28) as described above, adapted to balance the net torque applied to the motor.

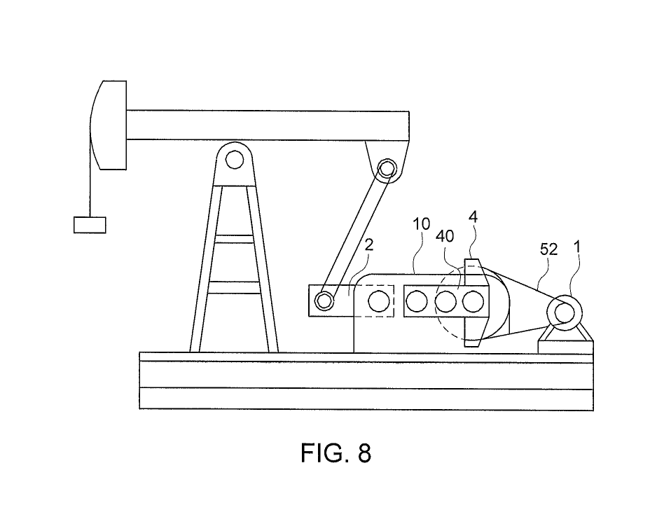

FIG. 8 shows an alternative approach to eliminate any overlap or interruption between the first crank arm (2) and balance crank (40). This is achieved by moving the loading crank arm (2) laterally so that it does not rotate in the same vertical plane as the balance crank (40). This may be accomplished by using a single balance crank (40) on one side of the gearbox, while the first crank arm (2) is disposed on the opposing side of the gearbox.

In a further alternative, the pumpjack may comprise a second counterweight (60) which is attached to the first crank arm (2), which is synchronized with the first counterweight (4) which is attached to the balance crank arm (40). The second counterweight and the first counterweight are either spaced sufficiently apart, or are disposed on opposite sides of the gearbox, so as to avoid overlap or interference with each other.

### DEFINITIONS AND INTERPRETATION

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

What is claimed is:

1. A torque balancing gearbox having a drive input and a load output, and comprising a first non-circular gear driven directly or indirectly by the drive input and engaging a second non circular gear which directly or indirectly drives the load output, each non-circular gear having a centre of rotation, and having a radius R1 or R2 from the centre of rotation to the point of engagement with the other non-circular gear, wherein the sum of R1 and R2 remains substantially constant through a rotation cycle, while the ratio R1/R2 varies from a minimum below 1.0 to a maximum above 1.0.

2. A reciprocating pumpjack comprising a motor and the gearbox of claim 1.

3. The gearbox of claim 1 further comprising a counterweight disposed on the end of a balance crank arm, which counterweight rotates together with the first non-circular gear, which counterweight counteracts torque applied by the load through the second non-circular gear.

4. The gearbox of claim 3 wherein the counterweight crank arm is displaced horizontally or laterally from a load output crank arm.

5. The gearbox of claim 1, 3 or 4 wherein the non-circular gears are elliptical in shape.

6. The gearbox of claim 1, 3 or 4 wherein the non-circular gears are circular with a non-centred axis of rotation.

7. The gearbox of claim 1 further comprising speed reduction gears which drive or are driven by the non-circular gears.

8. The pumpjack of claim 2 wherein the torque balancing gearbox further comprises speed reduction gears which drive or are driven by the non-circular gears, or comprising a speed reduction gearbox disposed between the motor and the torque balancing gearbox.
